(19) United States
(12) Patent Application Publication
(10) Pub. No.: US 2003/0009597 A1
(43) Pub. Date: Jan. 9, 2003

(54) Home network connection apparatus and control method thereof

(76) Inventor: Chul Yong Joung, Seoul (KR)

Correspondence Address: BIRCH STEWART KOLASCH & BIRCH, PO BOX 747, FALLS CHURCH, VA, 22040-0747, US

(21) Appl. No.: 09/891,366

(22) Filed: Jun. 27, 2001

(51) Int. Cl. G06F 15/16

(52) U.S. Cl. 709/249; 709/203

(57) ABSTRACT

A home network connecting apparatus in which a plurality of IEEE 1394 interface standard based home appliances are connected to access the Internet, includes: an appliance having a Web server proxy agent for fetching information on an appliance connected to a home network to generate a home page, providing an HTML film format information on the appliance connected to the home network to a remote area, transmitting control information of the appliance connected to the home network received from the remote area to a pertinent appliance; and transmitting an operation result of the pertinent appliance to the remote area; and an appliance having a web server FCM (Functional Component Module) operated according to a control command received from the appliance having the Web server proxy agent, wherein the two appliances are connected with a HAVi digital network. A model for the Web server FCM and the Web server proxy agent is proposed and connected to the HAVi home network by using the Internet, a request from the remote area through the Internet can be processed in the HAVi home network. In addition, since the home appliances connected to the HAVi home network share the resources of Web-accessible appliances (i.e., Internet Application Protocol, TCP, IP or Hardware, etc.), so that other appliances can process the request signal from the Internet only with an HTML file as provided.

### BACKGROUND OF THE INVENTION

1. Field of the Invention

The present invention relates to a home network apparatus, and more particularly, to a home network connecting apparatus for communicating an appliance connected with internet with another appliance connected with the home network and a control method thereof.

2. Description of the Background Art

With the development of digital techniques, digital electronic home appliances (for example, DTV, STB, DVD, DVHS or DVC, etc.) come into the market, for which a method for connecting the digital products are sought and standard is defined therefor.

A home audio video interoperability (HAVi) is one of the standards for constructing a home network by connecting home appliances in conformity to the 1394 Interface standard. The HAVi is a middle ware which allows the electric appliances and a personal computer in the home to construct a home network on the basis of the IEEE1394 and an IEC61883 standard and perform an interoperability.

FIG. 1 shows a conceptual protocol stack of the HAVi.

As shown in FIG. 1, the HAVi-compliant appliance has a software structure, and an HAVi standard defines software modules between an interoperability API and a platform specific API.

The functional component module (FCM) provides an API for controlling functions of an appliance. In the HAVi, there are defined a tuner FCM, a VCR FCM, a clock FCM, a camera FCM, an AV Disc FCM, an amplifier FCM, a display FCM, an AV Display FCM, a modem FCM and a Web Proxy FCM.

A messaging system serves as an information input/output path between an event manger, a registry, a stream manager, a resource manager, a DCM manager. A 1394 Communication Media Manager detects a bus reset of each home appliance connected to the 1394 line, that is, a connection or disconnection of a pertinent appliance and provides such an event information to an event manager.

The registry is a part for providing information on what FCM is being operated, the resource manager is a part for adjusting a collision when the collision occurs between specific functions, and the DCM manager is a part for performing turning on or off of an arbitrary appliance.

FIG. 2 is a view illustrating the construction and connection between the HAVi home network and an external Web server.

As shown in FIG. 2, a Web client 210 and a gateway system 220 are connected through the HAVi home network on the basis of the IEEE 1394 interface standard, and the gateway system 220 and a Web server 230 are connected by the Internet.

The Web client 210 is a home appliance having an arbitrary function. It includes an Internet protocol such as an HTTP 211 and a messaging system 212 for communicating with the Web gateway system 220.

The gateway system 220 is connected between the Web client 210 and the Web server 230 to serve as a Web gateway for providing an Internet protocol. The gateway system is provided by an arbitrary home appliance having an Internet accessible hardware and an Internet protocol stack in the HAVi home network.

That is, as an appliance having the Web proxy FCM 221 and an arbitrary function, the gateway system 220 performs a communication with the Web client 210 by using a messaging system 222, performs a communication with the Web server 230 by using a TC/IP based Internet communication device 223, and connects the message system 222 and the Internet communication device 223 by using the Web proxy FCM 221.

Accordingly, the Web server 230 includes the HTTP 231 and the TC[/IP based Internet communication device 232, so that when the gateway system 220 is connected through the Internet, the Web server 230 provides search information to the Web client 210.

FIG. 3 is a timing diagram showing a communication procedure between the Web client 210 and the Web proxy FCM 221 included in the gateway system 220.

The Web proxy FCM 221 provides to the Web client 210 so that the Web client 210 is accessible to the Internet.

WebProxy::Open( )

WebProxy::Close( )

WebProxy::Send( )

<Client>::Receive( )

WebProxy::GetCapability( )

First, the Web client 210 opens an Internet protocol (i.e., http, etc.) by using ‘WebProxy::Open( ) API of the Web proxy FCM 221 which has determined where the Web proxy FCM 221 is positioned through the registry, and informs of a message size which can be received by one time.

At this time, the Web proxy FCM 221 is used as an HTTP agent, a connection ID (cid) is assigned to a Web client 210 and informs of the size of a message transmitted by one time.

Thereafter, when a connection is established, the Web client 210 transmits a http request signal through ‘WebProxy::Send( )’ API to the Web proxy FCM 221.

At this time, when the Web proxy FCM 221 receives a request signal from the Web client 210, it is connected with the Web server 230 by the TCP and transmits a request signal to the Web server 230.

Thereafter, when a response signal is transmitted from the Web server 230, the Web proxy FCM 221 transmits the content through ‘<Client>::Receive( ) API to the Web client 210.

Thereafter, in case where the Web client 210 is desired to be disconnected, the Web client 210 calls ‘WebProxy::Close( ) API from the Web proxy FCM 221.

That is, the HAVi home network provides a method in which the Web client 210 accesses the Internet through the Web proxy FCM 221.

However, currently, in the HAVi, there is no protocol for controlling an appliance connected through the HAVi home network in the home by using the Internet from an external remote area.

Thus, presently no method is available to control appliances connected through the HAVi home network in the home by using the Internet from the external remote area.

### SUMMARY OF THE INVENTION

Therefore, an object of the present invention is to provide a home network connecting apparatus from a remote area which is capable of controlling appliances from a remote area by registering the appliances connected to a HAVi home network in the home at each Web server, and a control method thereof.

To achieve these and other advantages and in accordance with the purpose of the present invention, as embodied and broadly described herein, there is provided a home network connecting apparatus in which a plurality of IEEE 1394 interface standard based home appliances are connected to access the Internet, including: an appliance having a Web server proxy agent for fetching information on an appliance connected to a home network to generate a home page, providing an HTML film format information on the appliance connected to the home network to a remote area, transmitting control information of the appliance connected to the home network received from the remote area to a pertinent appliance; and transmitting an operation result of the pertinent appliance to the remote area; and an appliance having a web server FCM (Functional Component Module) operated according to a control command received from the appliance having the Web server proxy agent, wherein the two appliances are connected with a HAVi digital network.

To achieve the above objects, there is also provided a method for controlling a home network connecting apparatus including: a step in which when an appliance having a Web server FCM is turned on, an SEID is assigned and registered as a Web server FCM in a software element (SE) of a home network; a step in which when the Web server FCM comes in, the appliance having a Web proxy server agent fetches an image file from the connected appliance and construct a home page of the Web servers connected to the home network; a step in which when a user from a remote area accesses the home page of the home network through the Internet and selects an icon having LINK information, an appliance having a Web proxy server agent fetches control information from the selected appliance and provides it to the remote area user; a step in which when the remote area user selects one of the control information of the selected appliance, the information is transmitted to the appliance having the Web server FCM to perform a corresponding operation; and a step in which after the appliance having the Web server FCM performs the corresponding operation, the result is transmitted through the appliance having the Web server proxy agent to a remote area.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a drawing illustrating the structure of a HAVi protocol in accordance with a conventional art;

FIG. 2 is a drawing illustrating the construction in accordance with a conventional art;

FIG. 3 is a drawing illustrating a timing of a communication between a Web client and a Web proxy FCM in accordance with the conventional art;

FIG. 4 is a drawing illustration the construction in accordance with a preferred embodiment of the present invention;

FIG. 5 is an exemplary view of a first home page of the Web proxy FCM n accordance with the preferred embodiment of the present invention; and

FIG. 6 is an exemplary view of a first home page of a Web server in accordance with the preferred embodiment of the present invention.

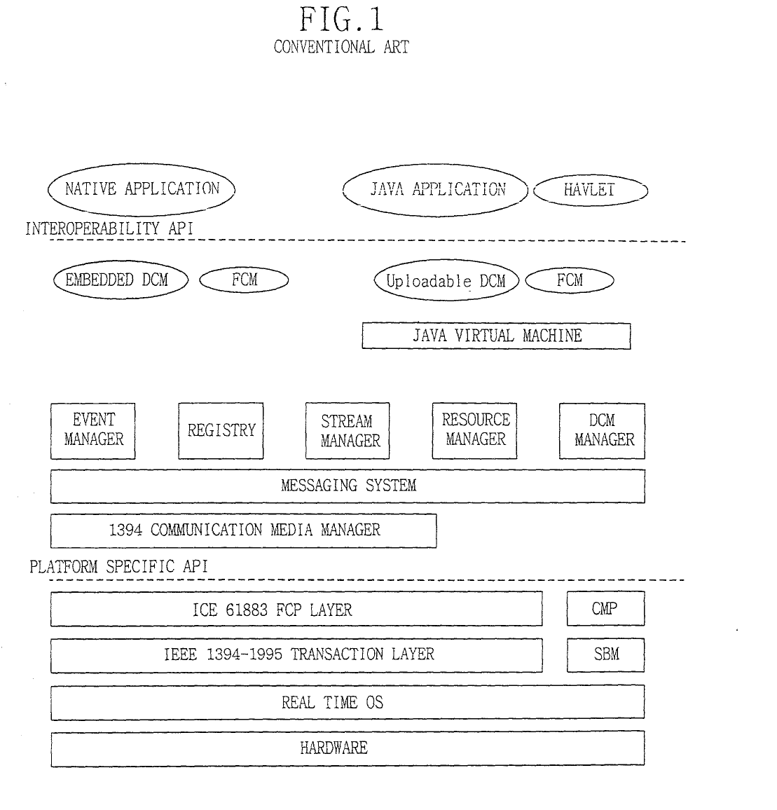

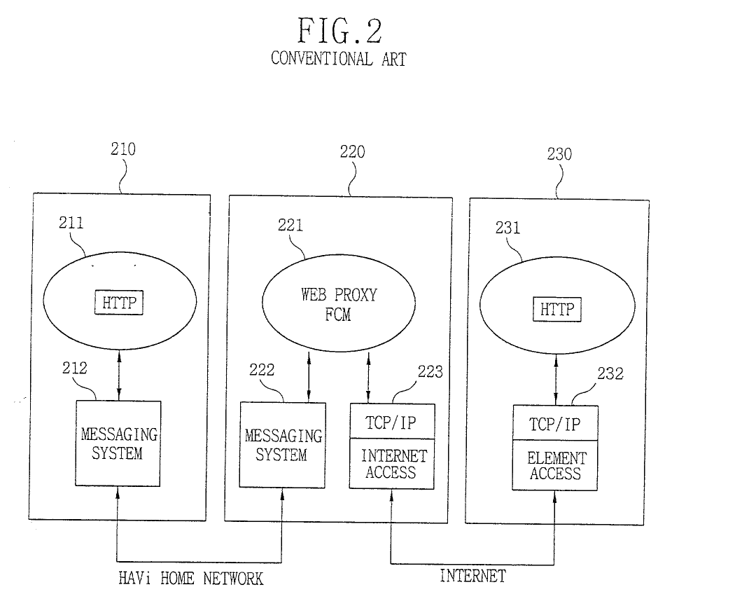

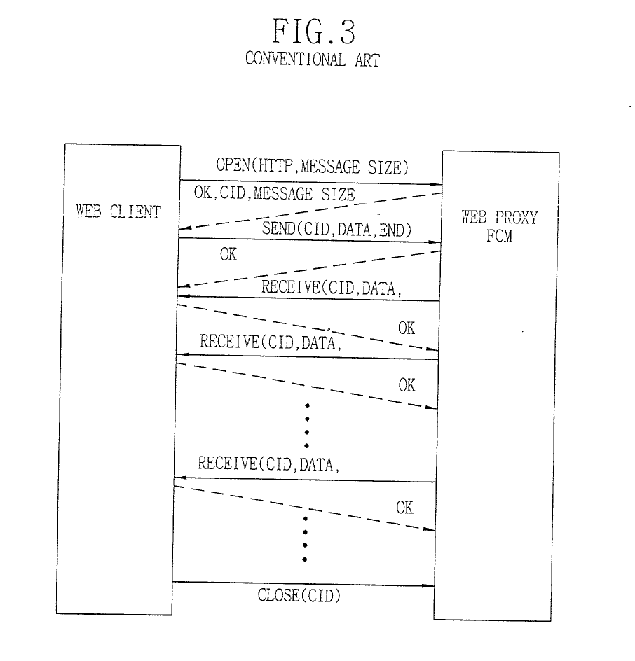

### DETAILED DESCRIPTION OF THE PREFERRED EMBODIMENTS

Reference will now be made in detail to the preferred embodiments of the present invention, examples of which are illustrated in the accompanying drawings.

Appliances connected to the HAVi home network are operated by a Web server which provides an HTML file in which a control method has been recorded, and an appliance having an Internet communication instrument includes a Web server proxy agent.

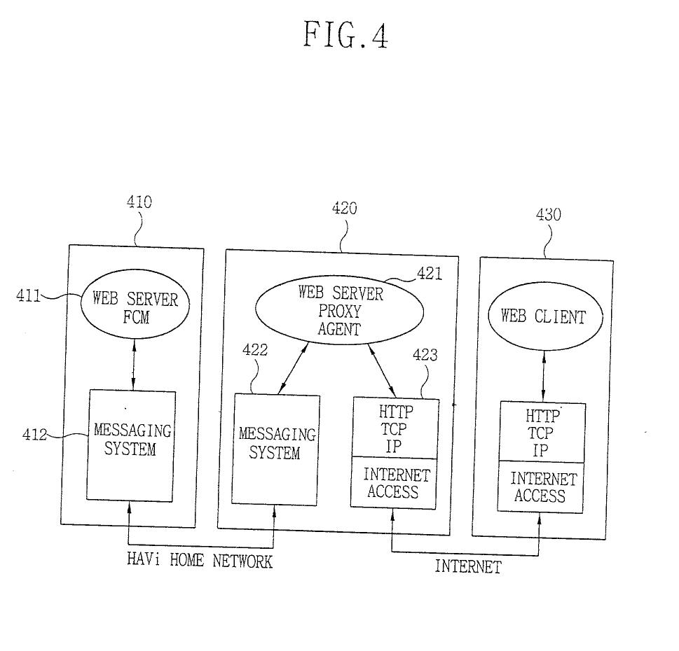

That is, referring to the connection between the HAVi home network and an external Web client, as shown in FIG. 4, the Web server 410 and the gateway system 420 are connected by the IEEE 1394 interface standard based HAVi home network, and the gateway system 420 and the Web client 430 are connected by the Internet.

First, in order to provide an HTML file with a control flow recorded, a Web server FCM 411 included in the Web server 410 defines an API as follows.

```
StatusWebServer::GetHTMLFile(
          In sequence<octet>link
          Out sequence<octet>html)
```

wherein ‘link’, an input parameter, is a HTML file to be provided, and ‘html’, an output parameter, signifies the HTML file corresponding to ‘link’.

A Web server proxy agent 421 included in the gateway system 420 performs editing of a dynamic home page, providing a link information or a Web server demon to process a request signal of the Web client 430 received from the Internet.

The dynamic home page editing function refers to a function of recognizing an appliance operable by the Web server among the appliances connected to the HAVi home network and fabricating a home page (or a first page view).

That is, in the HAVi home network connected by the 1394 cable, since the appliance connected to the network may be dynamically plugged in or plugged out, the Web proxy agent 421 changes a content of the home page each time.

According to the link information providing function, the appliances having the Web proxy agent among the home appliances connected to the HAVi home network are set as a root directory and the appliances having the Web server FCM are set as a child directory to inform pass information of a link in the HTML file.

That is, since the HAVi home network is a distributed file system in which the HTML file is distributed to several appliances in the network, such a link information is necessary.

The name of the child directory is set as a BUID (Global Unique ID) of the pertinent appliance.

The Web server demon function is to receive a request signal coming through the Internet and provide a HTML file over the control information of the pertinent appliance.

The operation of the embodiment of the present invention proposed on the basis of the above-described concept will now be described focussing on the Web server FCM and the Web server proxy agent.

First, the HAVi protocol based Web server 410 is an appliance having an arbitrary function. When a power is ON, the Web server FCM 411 included in the appliance is assigned an SEID by the Web server proxy agent 421 included in the gateway system 420 by using the MsgOpen( )API of the messaging system 412 and registers 'WEBSERVER_{—‘FCM’ for a software element (SE) type attribute in the ‘registry’.}

The gateway system 420 having a Web server proxy agent is an appliance having an arbitrary function. When a network reset occurs as a power is ON or an appliance connected to the HAVi home network is plugged in or out, the following function is performed.

The Web server proxy agent 421 included in the gateway system 420 checks whether there is an FCM which has registered ‘WEBSERVER_FCM’ for the SE type attribute in the ‘registry’.

If a new FCM is discovered in comparison with the existing data base(DB), that is, if a Web server 410 having the Web server 211 is plugged in to the network, the Web server proxy agent 421 adds an WEID of the FCM to the data base (DB).

Thereafter, since the new Web server FCM has come in, the Web server proxy agent 421 updates the home page in the following manner.

‘DCM::GetDevicelcon( ) is performed to fetch an image file from the appliance which has plugged in.

‘link’ information is assigned to the image file as ‘. . . WguidWindex.html’

Conversely, if the FCM has gone off in comparison with the existing data base (DB), that is, if an arbitrary appliance has been plugged out from the home network, the Web server proxy agent 421 deletes it from the data base (DB) and removes ‘link’ from the home page.

By proceeding the above process, a home page carrying information on the Web servers currently connected to the HAVi home network is made.

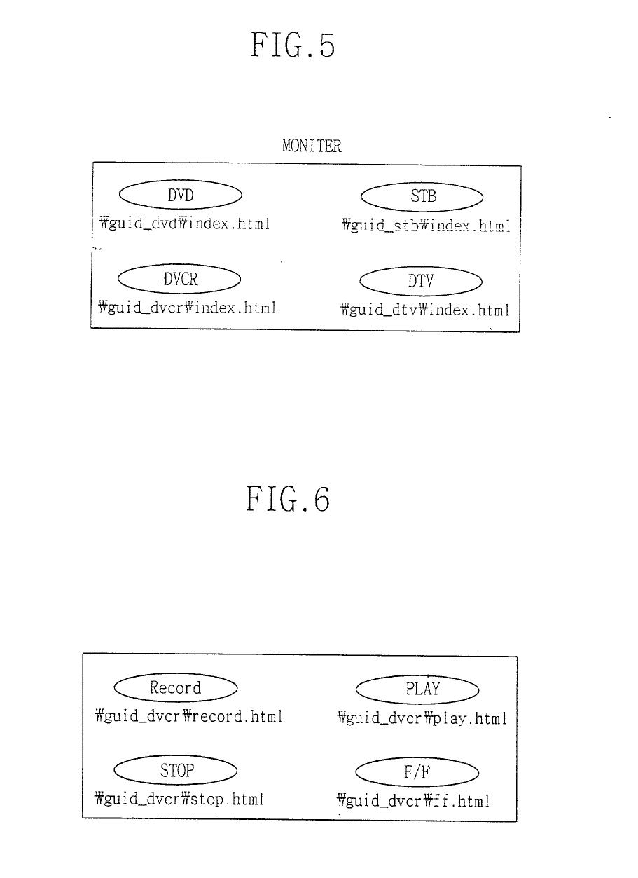

That is, when a request signal is received through an IP address or a URL of the home network from the Internet, a first home page (html view) provided from the gateway system 420 to the Web client 430 is as shown in FIG. 5.

At this time, when a user at the Web client 430 of a remote area connects to the HAVi network in the home by using the Internet, the Web server proxy agent 421 of the gateway system 420 provides a home page as shown in FIG. 5.

Accordingly, the Web client 430 selects an icon of an appliance desired to be controlled among the icons having the ‘link’ information illustrated in the home page of FIG. 5.

At this time, the Web server proxy agent 421 included in the gateway system 420 fetches ‘index.html’ from the Web server 410, a pertinent appliance’ by using ‘WebServer::GetHTMLFile(link,html) API of the Web server FCM 411.

In ‘index.html, control information of the pertinent appliance is recorded in the HTML format. For example, in case of the DVCR, the ‘index.html’ is as shown in FIG. 6.

In case that the user selects ‘PLAY Link’ from the home page of FIG. 6, the Web server FCM 411, when the Web server FCM 411 receives ‘play.html’ through Webserver::GetHTMLFile(link,html) API from the Web server proxy agent 421, a play function of a pertinent appliance is performed and ‘play.html’, a response html file, is outputted to the Web server proxy agent 421.

During the playing operation, when a stop operation is intended to be performed, the user from the Web client 430 of the remote area selects ‘STOP Link’ displayed on ‘index.html’ of the DVCR, to thereby stops playing of the DVCR.

In the preferred embodiment of the present invention, one Web server is subjected for descriptions of the operation. But according to which appliance is connected to the home network, a function of a desired home appliance can be controlled by making the home page as shown in FIG. 5.

That is, in the present invention, the HTML file existing in several appliances of the HAVi home network is managed through the Web server proxy agent, and whenever a network reset occurs, the first home page is dynamically updated to connect the Internet and the HAVi network.

In addition, the appliances connected to the home network process the request signal received from the Internet through the Web server FCM and transmits the response signal, thereby being controlled by the personal computer or an Internet access apparatus at the remote area.

As so far described, a home network connecting apparatus from a remote area and a control method thereof have many advantages.

For example, first, a model for the Web server FCM and the Web server proxy agent is proposed and connected to the HAVi home network by using the Internet, a request from the remote area through the Internet can be processed in the HAVi home network.

Secondly, since the home appliances connected to the HAVi home network share the resources of Web-accessible appliances (i.e., Internet Application Protocol, TCP, IP or Hardware, etc.), so that other appliances can process the request signal from the Internet only with an HTML file as provided.

Thirdly, though link information of the html file is dispersed in appliances connected to the HAVi home network, the pertinent appliance can be identified by using ‘GUID’, so that the pertinent appliance can be easily controlled from a remote area.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A home network connecting apparatus for communicating with an Internet comprising:
an appliance having a Web server proxy agent for fetching information on an appliance connected to a home network to generate a home page, providing an HTML film format information on the appliance connected to the home network to a remote area, transmitting control information of the appliance connected to the home network received from the remote area to a pertinent appliance and transmitting an operation result of the pertinent appliance to the remote area; and
an appliance having a web server FCM (Functional Component Module) operated according to a control command received from the appliance having the Web server proxy agent, wherein the two appliances are connected with a digital network.

2, The apparatus of claim 1, wherein, when a power is ON or in occurrence of a network reset due to a plug-in/plug-out of the appliance having the Web server FCM, the Web server proxy agent performs adding or deleting of the pertinent Web server FCM and updates a home page containing link information of the pertinent appliance.

3. The apparatus of claim 2, wherein the link information of the home page contains GUID of the pertinent appliance.

4. The apparatus of claim 1, wherein the appliance having the Web proxy server agent includes its own FCM.

5. The apparatus of claim 1, wherein the digital network is a HAVi.

6. The apparatus of claim 1, wherein the information is transmitted as a file of a format such as HTML.

7. The apparatus of claim 1, wherein the FCM is transmitted in the following API format:
StatusWebServer::GetHTMLFile(
In sequence<octet>link
Out sequence<octet>html)
wherein link is link information of the HTML file and the HTML is a HTML file corresponding to the link.

8. The apparatus of claim 1, wherein the appliances having the Web proxy agent among the home appliances connected to the home network are set as a root directory and the GUID of an appliance having the Web server FCM is set as a child directory to inform pass information of a link.

9. The apparatus of claim 1, wherein the appliance having the proxy server receives a request signal inputted through the Internet and provides an HTML file for the pertinent appliance.

10. The apparatus of claim 1, wherein the Web proxy server agent is included in one of the appliances connected to the home network.

11. A method for controlling a home network connecting apparatus comprising:
a step in which when an appliance having a Web server FCM is turned on, an SEID is assigned and registered as a Web server FCM in a software element (SE) of a home network;
a step in which when the Web server FCM comes in, the appliance having a Web proxy server agent fetches an image file from the connected appliance and construct a home page of the Web servers connected to the home network;
a step in which when a user from a remote area accesses the home page of the home network through the Internet and selects an icon having LINK information, an appliance having a Web proxy server agent fetches control information from the selected appliance and provides it to the remote area user; and
a step in which when the remote area user selects one of the control information of the selected appliance, the information is transmitted to the appliance having the Web server FCM to perform a corresponding operation.

12. The method of claim 11, wherein the step of constructing a home page comprises:
determining whether there is a FCM which has been registered as a Web server FCM, when the network is reset;
adding an SEID of a new FCM, if there is a new FCM;
fetching an image file from an appliance where the SEID has been added and assigning link information in a html file format; and
deleting a SEID of a FCM and link information if the FCM has been registered the Web server FCM and released from the Web server FCM.

13. The method of claim 11, further comprising a step in which after the appliance having the Web server FCM performs the corresponding operation, the result is transmitted through the appliance having the Web server proxy agent to a remote area.
